(19) United States
(12) Patent Application Publication
(10) Pub. No.: US 2023/0040170 A1
(43) Pub. Date: Feb. 9, 2023

(54) THREE-DIMENSIONAL PRINTING WITH WETTING AGENT

(71) Applicant: Hewlett-Packard Development Company, L.P., Spring, TX (US)

(72) Inventors: Natalie Harvey, Corvallis, OR (US); Vladek Kasperchik, Corvallis, OR (US); Emily Register, Roswell, GA (US)

(73) Assignee: Hewlett-Packard Development Company, L.P., Spring, TX (US)

(21) Appl. No.: 17/788,364

(22) PCT Filed: Jan. 10, 2020
(86) PCT No.: PCT/US2020/013008

§ 371 Date: Jun. 23, 2022

(51) Int. Cl. C09D 7/40; B33Y 10/00; B33Y 30/00; B33Y 70/10; B22F 10/14; C09D 7/20; C09D 7/61

(52) U.S. Cl. CPC C09D 7/69; B33Y 10/00; B33Y 30/00; B33Y 70/10; B22F 10/14; C09D 7/20; C09D 7/61; C08K 3/11

(57) ABSTRACT

A three-dimensional printing kit can include a wetting agent, a binding agent, and a particulate build material. The wetting agent an include water, from about 5 wt % to about 60 wt % organic co-solvent, and from about 0.1 wt % to about 10 wt% surfactant. The binding agent can include from about 2 wt % to about 25 wt % polymer binder and a liquid vehicle. The particulate build material can include from about 80 wt % to 100 wt % metal particles that can have a D50 particle size ranging from about 2 gm to about 150 μm.

### BACKGROUND

Three-dimensional (3D) printing may be an additive printing process used to make three-dimensional solid parts from a digital model. Three-dimensional printing can be used in rapid product prototyping, mold generation, mold master generation, and short run manufacturing. Some three-dimensional printing techniques can be considered additive processes because they involve the application of successive layers of material. This can be unlike other machining processes, which often rely upon the removal of material to create the final part. Some three-dimensional printing methods can use chemical binders or adhesives to bind build materials together. Other three-dimensional printing methods involve partial sintering, melting, etc. of the build material. For some materials, partial melting may be accomplished using heat-assisted extrusion, and for some other materials curing or fusing may be accomplished using, for example, ultra-violet light or infrared light.

### BRIEF DESCRIPTION OF THE DRAWINGS

FIG. 1 graphically illustrates an example three-dimensional printing kit in accordance with the present disclosure;

FIG. 2 is a flow diagram illustrating an example method of three-dimensional printing in accordance with the present disclosure; and

FIG. 3 graphically illustrates a three-dimensional printing system in accordance with the present disclosure.

### DETAILED DESCRIPTION

Three-dimensional (3D) printing can be an additive process that can involve the application of successive layers of particulate build material with chemical binders or adhesives printed thereon to bind the successive layers of the particulate build material together. In some processes, application of a binding agent with a binder therein can be utilized to form a green body object and then a fused three-dimensional physical object can be formed therefrom. More specifically, a binding agent can be selectively applied to a layer of a particulate build material on a support bed to pattern a selected region of the layer of the particulate build material and then another layer of the particulate build material can be applied thereon. The binding agent can be applied to another layer of the particulate build material and these processes can be repeated to form a green part (also known as a 3D green body or object) which can then be heat fused to form a fused 3D object.

A surface topography of the build material can influence the overall quality and strength of the three-dimensional object printed therefrom. For example, a binding agent can impact a layer of the particulate build material with a velocity and force that can disrupt the layer of the particulate build material. Droplets of the binding agent can create structural defects, such as craters, by ejecting loose particles and/or irregular agglomeration of particles. In addition, binding agents can exhibit delayed infiltration into a layer of the particulate build material. These printing interactions can result in surface roughness on a printed object and can create cavities in a green body object. Cavities in a green body object can inversely relate to density in a fused three-dimensional object. Green body objects with more cavities (either in quantity or volume) can be less dense than green body objects with fewer cavities. An increase in a cavity space of a green body object can decrease a density of the fused three-dimensional object, leaving the three-dimensional object subjectable to fatigue and/or cracking.

In accordance with this, in one example, a three-dimensional printing kit (or “kit”) can include a wetting agent, a binding agent, and a particulate build material. The wetting agent can include water, from about 5 wt % to about 60 wt % organic co-solvent, and from about 0.1 wt % to about 10 wt % surfactant. The binding agent can include from about 2 wt % to about 25 wt % polymer binder and a liquid vehicle. The particulate build material can include from about 80 wt % to 100 wt % metal particles that can have a D50 particle size ranging from about 2 μm to about 150 μm. In an example, the surfactant can be a nonionic surfactant, such as for example, an ethoxylated nonionic surfactant. In another example, the organic co-solvent can include a C3 to C8 diol. In yet another example, the organic co-solvent can include ethanol, methanol, acetone, tetrahydrofuran, hexane, 1-butanol, 2-butanol, tert-butanol,1-propanol, isopropanol, methyl ethyl ketone, dimethylformamide, 1,4-dioxone, acetonitrile, 1,2-butanediol, 1-methyl-2,3-propanediol, 2-pyrrolidone, or a combination thereof. In a further example, the polymer binder can include latex polymer particles that can have a D50 particle size from about 50 nm to about 1 μm. In one example, the metal particles can include aluminum, titanium, copper, cobalt, chromium, nickel, vanadium, tungsten, tungsten carbide, tantalum, molybdenum, magnesium, gold, silver, stainless steel, tool steel, steel, an alloy thereof, or an admixture thereof.

In another example, a method of three-dimensional printing (or “method”) can include iteratively applying individual build material layers of a particulate build material onto a powder bed, where the particulate build material can include from about 80 wt % to 100 wt % metal particles that can have a D50 particle size ranging from about 2 pm to about 150 μm; and based on a 3D object model, iteratively applying a wetting agent to individual build material layers, where the wetting agent can include water, from about 5 wt % to about 60 wt % organic co-solvent, and from about 0.1 wt % to about 10 wt % surfactant. The method can further include, based on a 3D object model, iteratively and selectively applying a binding agent to individual build material layers at locations where the wetting agent has been applied to define individually patterned object layers that can become adhered to one another to form a layered green body object, where the binding agent can include from about 2 wt % to about 25 wt % polymer binder and a liquid vehicle. A weight ratio of the polymer binder to total liquid content applied from both the wetting agent and the binding agent to individual build material layers can range from about 1:5 to about 1:100 and from about 50 wt % to about 95 wt % of total liquid content applied to individual build material layers can be from the wetting agent. In an example, the method can further include sintering the layered green body object to form a heat-fused article. In another example, the fused three-dimensional object can have a surface area porosity from about 0.1° A to about 10%. In yet another example, the surfactant can be an ethyoxylated nonionic surfactant. In a further example, the organic co-solvent can include ethanol, methanol, acetone, tetrahydrofuran, hexane, 1-butanol, 2-butanol, tert-butano1,1-propanol, isopropanol, methyl ethyl ketone, dimethylformamide, 1,4-dioxone, acetonitrile, 1,2-butanediol, 1-methyl-2,3-propanediol, 2-pyrrolidone, or a combination thereof. In one example, the polymer binder can include latex polymer particles that can have a D50 particle size from about 50 nm to about 1 μm. In another example, the metal particles can include aluminum, titanium, copper, cobalt, chromium, nickel, vanadium, tungsten, tungsten carbide, tantalum, molybdenum, magnesium, gold, silver, stainless steel, tool steel, steel, an alloy thereof, or an admixture thereof

In another example, a three-dimensional printing system (or “system”) can include a first fluid ejector, a second fluid ejector, and a hardware controller. The first fluid ejector can be fluidly coupled to or fluidly coupleable to a wetting agent. The wetting agent can include water, from about 5 wt % to about 60 wt % organic co-solvent, and from about 0.1 wt % to about 10 wt % surfactant. The second fluid ejector can be fluidly coupled to or fluidly coupleable to a binding agent that can include from about 2 wt % to about 25 wt % polymer binder and a liquid vehicle. The hardware controller can generate a command to initially eject the wetting agent prior to initially ejecting the binding agent toward an individual layer of a particulate build material so that a weight ratio of the polymer binder to total liquid content from both the wetting agent and the binding agent that ejected into the individual layer can range from about 1:5 to about 1:100 with from about 50 wt % to about 95 wt % of the total liquid content ejected into the individual layer is provided by the wetting agent. In an example, the system can further include the particulate build material. The particulate build material can include from about 80 wt % to 100 wt % metal particles that can have a D50 particle size ranging from about 2 μm to about 150 μm.

When discussing the three-dimensional printing kits, the methods of three-dimensional printing, and/or the three-dimensional printing systems herein, these discussions can be considered applicable to one another whether or not they are explicitly discussed in the context of that example. Thus, for example, when discussing a wetting agent related to a three-dimensional printing kit, such disclosure is also relevant to and directly supported in the context of the method of three-dimensional printing, the three-dimensional printing system, and vice versa.

Terms used herein will have the ordinary meaning in the relevant technical field unless specified otherwise. In some instances, there are terms defined more specifically throughout the specification or included at the end of the present specification, and thus, these terms can have a meaning as described herein.

### Three-Dimensional Printing Kits

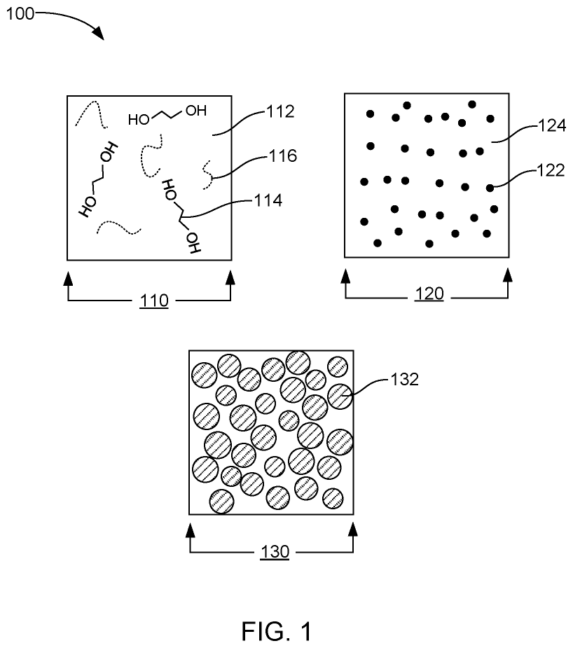

In accordance with examples of the present disclosure, a three-dimensional printing kit 100 is shown in FIG. 1. The three-dimensional printing kit can include a wetting agent 110, a binding agent 120, and a particulate build material 130. The wetting agent can include water 112, from about 5 wt % to about 60 wt % organic co-solvent 114 (shown by example as a lower alkyl diol, but could be any of a number of organic co-solvents or mixtures thereof), and from about 0.1 wt % to about 10 wt % surfactant 116. The binding agent can include from about 2 wt % to about 25 wt % polymer binder 122 and a liquid vehicle 124. The particulate build material can include from about 80 wt % to 100 wt % metal particles 132 that can have a D50 particle size that can range from about 2 μm to about 150 μm. The wetting agent, the binding agent, or both the wetting agent and the binding agent, may be packaged separately or co-packaged together to be used with the particulate build material, or may be co-packaged with the particulate build material in separate containers.

### Three-dimensional Printing Methods

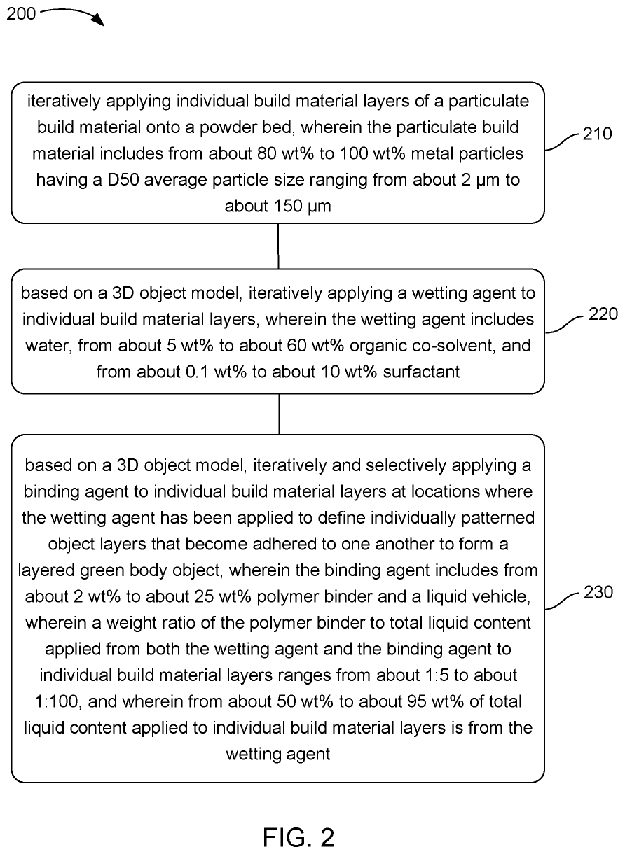

A flow diagram of an example method of three-dimensional (3D) printing 200 is shown in FIG. 2. It is noted that in one example, the three-dimensional printing kit used can be as described in the example set forth in FIG. 1. The method can include iteratively applying 210 individual build material layers of a particulate build material onto a powder bed, where the particulate build material can include from about 80 wt% to 100 wt % metal particles that can have a D50 particle size ranging from about 2 μm to about 150 μm; based on a 3D object model, iteratively applying 220 a wetting agent to individual build material layers, where the wetting agent can include water, from about 5 wt % to about 60 wt % organic co-solvent, and from about 0.1 wt % to about 10 wt % surfactant; and based on a 3D object model, iteratively and selectively applying 230 a binding agent to individual build material layers at locations where the wetting agent has been applied to define individually patterned object layers that can become adhered to one another to form a layered green body object, where the binding agent can include from about 2 wt % to about 25 wt % polymer binder and a liquid vehicle. A weight ratio of the polymer binder to total liquid content applied from both the wetting agent and the binding agent to individual build material layers can range from about 1:5 to about 1:100, about 1:20 to about 1:80, or from about 1:25 to about 1:75. From about 50 wt % to about 95 wt % or from about 60 wt % to about 80 wt % of total liquid content applied to individual build material layers can be from the wetting agent.

After an individual particulate build material layer is printed thereon with the wetting agent and the binding agent, in some instances the individual build material layer can be heated to drive off water and/or other liquid components, as well as to further solidify the layer of the 3D green body object. The heat can be applied from overhead and/or can be provided by a build platform from beneath the particulate build material. In other examples, the particulate build material can be heated prior to dispensing.

During printing, the build platform can be dropped a distance that can correspond to a thickness of particulate build material that can be spread for the next layer of the green body object or article to be formed, so that another layer of the particulate build material can be added thereon, printed with wetting agent, binding agent, heated, etc. This process can be repeated on a layer by layer basis until the green body object is formed.

Following the formation of the green body object, in one example, the green body object can be moved to an oven and fused by sintering and/or annealing.

The method can include heating the green body object to a de-binding temperature (ranging from about 300° C. to 550° C. or other temperature) in order to remove polymer binder via pyrolysis, and then further heating the green body object to a fusing temperature, typically ranging from about 600° C. to about 3,500° C. In one example, fusing of the green body object can be by sintering the metal particles together by typically bringing the particles to a temperature below melting temperature of the particulate build material so that the surfaces of the metal particles become fused together and consolidate into the final fused part or object. In some examples, the temperature can range from about 600° C. to about 1,500° C., from about 800° C. to about 1,500° C., from about 1,000° C. to about 1,400° C., from about 1,000° C. to about 3,000° C., or from about 600° C. to about 2,000° C., depending on the metal or metal alloy used.

When the binding agent is applied iteratively in layers on the particulate build material, the green body object can have the mechanical strength to withstand extraction from a powder bed and can then be sintered or annealed to form a heat-fused article. Once the green part or green body object is sintered or annealed, the article can sometimes be referred to as a “heat-fused” article, part, or object. The term “sinter” or “sintering” refers to the consolidation and physical bonding of the particles together (after temporary binding using the binding agent) by solid state diffusion bonding, partial melting of particles, or a combination of solid state diffusion bonding and partial melting. The term “anneal” or “annealing” refers to a heating and cooling sequence that controls the heating process and the cooling process, e.g., slowing cooling in some instances can remove internal stresses and/or toughen the heat-fused part or article. In some examples, the polymer binder contained in the binding agent can undergo a pyrolysis or burnout process where the polymer binder may be removed during sintering or annealing. This can occur where the thermal energy applied to a green body object removes inorganic or organic volatiles and/or other materials that may be present either by decomposition or by burning the binding agent.

After fusing the metal particles together, the heat-fused three-dimensional part or object can have a volume porosity that can range from about 0.1% to about 10%, from about 0.2% to about 8%, or from about 0.2% to about 5%. As used herein, “volume porosity” refers to a pore volume fraction of a sintered three-dimensional object.

### Three-dimensional Printing System

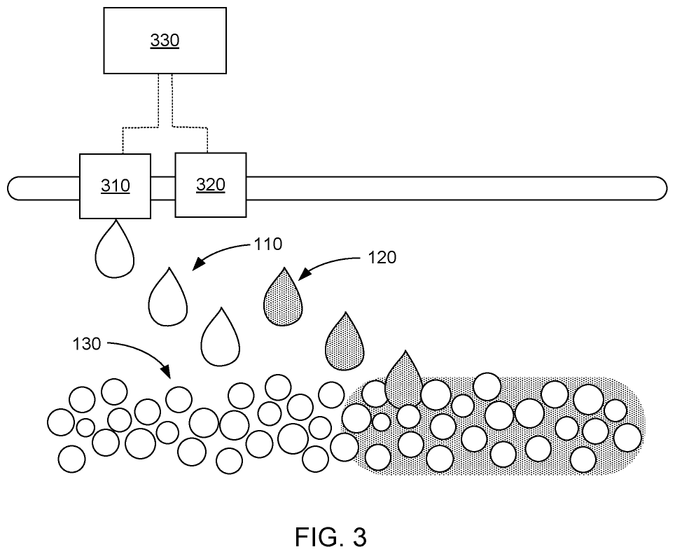

In another example, a three-dimensional printing system 300 is shown in FIG. 3, and can include a first fluid ejector 310, a second fluid ejector 320, and a hardware controller 330. The first fluid ejector can be fluidly coupled to or fluidly coupleable to a wetting agent 110. The wetting agent can include water, from about 5 wt % to about 60 wt % organic co-solvent, and from about 0.1 wt % to about 10 wt% surfactant. The second fluid ejector can be fluidly coupled to or fluidly coupleable to a binding agent 120 that can include from about 2 wt % to about 25 wt % polymer binder and a liquid vehicle. The hardware controller can generate a command to initially eject the wetting agent prior to initially ejecting the binding agent toward an individual layer of a particulate build material 130 so that a weight ratio of the polymer binder to total liquid content from both the wetting agent and the binding agent that can be ejected onto the individual layer can range from about 1:5 to about 1:100, about 1:20 to about 1:80, or from about 1:25 to about 1:75 and about 50 wt % to about 95 wt % or from about 60 wt % to about 80 wt % of the total liquid content ejected into the individual layer is provide by the wetting agent. In an example, the system can further include the particulate build material 130. The particulate build material can include from about 80 wt % to 100 wt % metal particles that can have a D50 particle size ranging from about 2 μm to about 150 μm.

In further detail, the first fluid ejector and/or the second fluid ejector can be any type of apparatus capable of selectively dispensing or applying the wetting agent or the binding agent. For example, the ejectors can be a fluid ejector or digital fluid ejector, such as an inkjet printhead, e.g., a piezo-electric printhead, a thermal printhead, a continuous printhead, etc. The ejectors could likewise be a sprayer, a dropper, or other similar structure for applying the wetting agent or the binding agent to the build material. Thus, in some examples, the application can be by jetting or ejecting from a digital fluid jet applicator, similar to an inkjet pen.

The hardware controller can include hardware and/or software operable to direct the placement and ejection of a fluid agent (wetting agent and/or binding agent) from the fluid ejectors. The hardware controller can be wired or wireless. The hardware controller can also control other components of the system, for example, or can coordinate with other controllers to cause the system to operate as intended. A structure of the hardware controller may not be limited.

In some examples, the first fluid ejector and/or the second fluid ejector may be included on a carriage track or other similar structure. It is noted, however, that there can be other application architecture alternatively. Furthermore, the particulate build material can be supported by a build platform, or more typically, by previously applied particulate build material layers, e.g., portions printed with a binding agent, portions printed with a wetting agent, and/or portions which may remain unprinted).

### Wetting Agents

Regarding the wetting agent that may be present in the three-dimensional printing kit, the three-dimensional printing system, or utilized in the method of 3D printing as described herein, the wetting agent can include water, from about 5 wt % to about 60 wt % organic co-solvent, and from about 0.1 wt % to about 10 wt % surfactant. The wetting agent can be used to wet a particulate build material prior to applying a binding agent. The wetting agent can act to minimize structural disruption of the particulate build material layer by impact of the binding agent and can increase penetration of the binding agent into a layer of the particulate build material.

The wetting agent can include from 30 wt % to about 94.9 wt % water. In other examples, water can be present at from 40 wt % to about 80 wt %, from 50 wt % to about 75 wt %, or from 60 wt % to about 94.9 wt % in the wetting agent. In some examples, the water can be deionized.

The wetting agent can also include from about 5 wt % to about 60 wt % of an organic co-solvent. In yet other examples, the wetting agent can include from about 5 wt % to about 50 wt %, from about 10 wt % to about 30 wt %, from about 10 wt % to about 40 wt %, from about 25 wt % to about 50 wt % or from about 40 wt % to about 60 wt % of an organic co-solvent. In an example, the organic co-solvent can be a C3 to C8 diol. In another example, the organic co-solvent can include ethanol, methanol, acetone, tetrahydrofuran, hexane, 1-butanol, 2-butanol, tert-butanol, 1-propanol, isopropanol, methyl ethyl ketone, dimethylformamide, 1,4-dioxone, acetonitrile, 1,2-butanediol, 1-methyl-2,3-propanediol, 2-pyrrolidone, or a combination thereof. In yet another example, the organic co-solvent can include 1,2-butanediol, ethanol, methanol, acetone, hexane, or a combination thereof. In a further example, the organic co-solvent can include 1,2-butanediol. In some examples, the organic co-solvent be water-miscible.

In some examples, the organic co-solvent can have a surface tension that can be less than the surface tension of water (e.g., 72.8 milli-Newtons per meter at 20° C.). Having a lower surface tension than water can allow the amphiphilic water-miscible solvent to uniformly wet a particulate build material faster than water and can minimize particle displacement when applied to a particulate build material. A surface tension of a fluid can be measured by tensiometer.

The organic co-solvent can also have a boiling point less than water. In one example, the organic co-solvent can have a boiling point that can range from about 50° C. to less than about 100° C. In yet other examples, the organic co-solvent can have a boiling point that can range from about 55° C. to about 95° C., from about 60° C. to about 80° C., or from about 65° C. to about 80° C.

The wetting agent can further include from about 0.1 wt % to about 10 wt % surfactant. In yet other examples, the wetting agent can include from about 0.1 wt % to about 5 wt %, from about 0.5 wt % to about 7 wt %, from about 1 wt % to about 8 wt %, or from about 1 wt % to about 3 wt % surfactant.

In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom).

In some examples, the surfactant can be a non-ionic surfactant. In another examples, the surfactant can be an ethoxylated non-ionic surfactant. Examples can include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. Commercially available examples of non-ionic surfactants that can be used includes SURFYNOL®SEF, SURFYNOL®104, SURFYNOL® 440, or DYNOL® 360 (all available from Evonik Industries AG, Germany); TERGITOL® TMN6, TERGITOL® 15S5, TERGITOL® 15S7 (all available from Dow, USA); CAPSTONE™ FS-35 (The Chemours Company, USA); or the like. Example anionic surfactants that can be use include phosphate ester of a C10 to C20 alcohol or a polyethylene glycol (3) oleyl mono/di phosphate, CRODAFOS™ N3 Acid (available from Croda International Plc., Great Britain); sodium dodecyl sulfate, or the like. In some examples, the wetting agent can exclude anionic surfactants.

In some examples, the wetting agent can further include a colorant. The colorant can include a pigment, a dye, or both a pigment and a dye. In some examples, there is no colorant present. However, in other examples, where a colorant is included, it may be included for the purpose of providing a visual clue or indicator that the wetting agent has been applied at a given location, or to provide an indicator or clue as to nozzle health. As the present disclosure is drawn to printing and then heat-fusing green body objects to form heat-fused metal objects, typically the colorant would burn off during sintering or annealing. Thus, small concentrations of colorant can be used, if at all. If included, the colorant can be present up to 5 wt %, for example. Example ranges may be from about 0.01 wt % to about 5 wt %, from about 0.1 wt % to about 4 wt %, or from about 0.2 wt % to about 2 wt.

### Binding Agents

In further reference to the binding agent that may be present in the three-dimensional printing kit, the three-dimensional printing system, or utilized in the method of three-dimensional printing as described herein, the binding agent can include a liquid vehicle and a polymer binder to bind the particulate build material together during the build process to form a green body object. The term “binder” can include any material used to physically bind the particles of the particulate build material, e.g., metal particles, ceramic particles, etc., together or facilitate adhesion to a surface of adjacent particles in order to prepare a green part or green body object in preparation for subsequent heat-fusing, e.g., sintering, annealing, melting, etc. During three-dimensional printing, a binding agent can be applied to the particulate build material on a layer by layer basis. The liquid vehicle of the binding agent can be capable of wetting a particulate build material and the polymer binder can move into vacant spaces between particles of the particulate build material, for example.

The binding agent can provide binding to the particulate build material upon application, or in some instances, can be activated after application to provide binding. The polymer binder can be activated or cured by heating the polymer binder (which may be accomplished by heating an entire layer of the particulate build material on at least a portion of the binding agent which has been selectively applied). For the polymer binder this may occur at about the glass transition temperature of the polymer binder, for example. When activated or cured, the polymer binder can form a network that can adhere or glue particles of the particulate build material together, thus providing cohesiveness in forming and/or holding the shape of the green body object or a printed layer thereof. A “green” part or green body object or article (or individual layer) can refer to any component or mixture of components that are not yet sintered or annealed, but which are held together in a manner sufficient to permit heat-fusing, e.g., handling, moving, or otherwise preparing the part for heat-fusing.

The polymer binder can be included, as mentioned, in a liquid vehicle for application to the particulate build material. For example, the polymer binder can be present in the binding agent at from about 2 wt % to about 25 wt %, from about 2 wt % to about 12 wt %, from about 5 wt % to about 15 wt %, from about 5 wt % to about 10 wt %, or from about 7.5 wt % to about 25 wt % in the binding agent.

In one example, the polymer binder can include latex polymer particles. The latex polymer particles can have a D50 particle size that can range from about 100 nm to about 1 μm. In other examples, the polymer particles can have a D50 particle size that can range from about 500 nm to about 700 nm, from about 100 nm to about 500 nm, from about 200 nm to about 800 nm, or from about 250 nm to about 750 nm.

In one example, the latex particles can include any of a number of copolymerized monomers, and may in some instances include a copolymered surfactant, e.g., polyoxyethylene compound, polyoxyethylene alkylphenyl ether ammonium sulfate, sodium polyoxyethylene alkylether sulfuric ester, polyoxyethylene styrenated phenyl ether ammonium sulfate, etc. The copolymerized monomers can be from monomers, such as styrene, p-methyl styrene, α-methyl styrene, methacrylic acid, acrylic acid, acrylamide, methacrylamide, 2-hydroxyethyl acrylate, 2-hydroxyethyl methacrylate, 2-hydroxypropyl acrylate, 2-hydroxypropyl methacrylate, methyl methacrylate, hexyl acrylate, hexyl methacrylate, butyl acrylate, butyl methacrylate, ethyl acrylate, ethyl methacrylate, 2-ethylhexyl acrylate, 2-ethylhexyl methacrylate, propyl acrylate, propyl methacrylate, octadecyl acrylate, octadecyl methacrylate, stearyl methacrylate, vinylbenzyl chloride, isobornyl acrylate, tetrahydrofurfuryl acrylate, 2-phenoxyethyl methacrylate, benzyl methacrylate, benzyl acrylate, ethoxylated nonyl phenol methacrylate, ethoxylated behenyl methacrylate, polypropyleneglycol monoacrylate, isobornyl methacrylate, cyclohexyl methacrylate, cyclohexyl acrylate, t-butyl methacrylate, n-octyl methacrylate, lauryl methacrylate, tridecyl methacrylate, alkoxylated tetrahydrofurfuryl acrylate, isodecyl acrylate, isobornyl methacrylate, isobornyl acrylate, dimethyl maleate, dioctyl maleate, acetoacetoxyethyl methacrylate, diacetone acrylamide, N-vinyl imidazole, N-vinylcarbazole, N-vinyl-caprolactam, or combinations thereof. In some examples, the latex particles can include an acrylic. In other examples, the latex particles can include 2-phenoxyethyl methacrylate, cyclohexyl methacrylate, cyclohexyl acrylate, methacrylic acid, combinations thereof, derivatives thereof, or mixtures thereof. In another example, the latex particles can include styrene, methyl methacrylate, butyl acrylate, methacrylic acid, combinations thereof, derivatives thereof, or mixtures thereof.

The liquid vehicle can be included in the binding agent at from about 50 wt % to about 98 wt %, from about 70 wt % to about 98 wt %, from about 80 wt % to about 98 wt %, from about 60 wt % to about 95 wt %, or from about 70 wt % to about 95 wt%, based on the weight of the binding agent as a whole. In one example, the liquid vehicle can include water as a major solvent, e.g., the solvent present at the highest concentration when compared to other co-solvents. In another example, the binding agent can further include from about 0.1 wt % to about 70 wt %, from about 0.1 wt % to about 50 wt %, or from about 1 wt % to about 30 wt % of liquid components other than water. The other liquid components can include organic co-solvent, surfactant, additive that inhibits growth of harmful microorganisms, viscosity modifier, pH adjuster, sequestering agent, preservatives, etc.

When present, organic co-solvent(s) can include high-boiling solvents and/or humectants, e.g., aliphatic alcohols, aromatic alcohols, alkyl diols, glycol ethers, polyglycol ethers, 2-pyrrolidinones, caprolactams, formamides, acetamides, C6 to C24 aliphatic alcohols, e.g. fatty alcohols of medium (C6-C12) to long (C13-C24) chain length, or mixtures thereof. The organic co-solvent(s) in aggregate can be present from 0 wt % to about 50 wt % in the binding agent. In other examples, organic co-solvents can be present at from about 5 wt % to about 35 wt %, from about 2 wt % to about 30 wt %, or from about 5 wt % to about 25 wt % in the binding agent.

### Particulate Build Materials

In further reference to the particulate build material that may be present in the three-dimensional printing kit, the three-dimensional printing system, or utilized in the method of three-dimensional printing as described herein, the particulate build material can include from about 80 wt % to 100 wt % metal particles. The metal particles can be selected from aluminum, titanium, copper, cobalt, chromium, nickel, vanadium, tungsten, tungsten carbide, tantalum, molybdenum, magnesium, gold, silver, stainless steel, tool steel, steel, an alloy thereof, or an admixture thereof. Metals included in the alloys can be any of the metals listed above, and/or may likewise include chromium, vanadium, tungsten, tungsten (tungsten carbide), tantalum, molybdenum, magnesium, etc., or even nonmetals or metalloids, such as silicon, boron, germanium, etc.

In an example, the metal particles can be a single phase metallic material composed of one element. In this example, the sintering temperature may be below the melting point of the single element. In another example, the metal particles can be composed of two or more elements, which may be in the form of a single phase metallic alloy or a multiple phase metallic alloy. In these other examples, sintering generally can occur over a range of temperatures. With respect to alloys, materials with a metal alloyed to a non-metal (such as a metal-metalloid alloy) can be used as well.

The temperature(s) at which the metallic particles of the particulate build material sinter can be above the temperature of the environment in which patterning (with the binding agent) is performed (e.g., patterning at from about 40° C. to about 250° C.). In some examples, the metal particles may be sintered at from about 500 ° C. to about 3,500° C., depending on the material. Other temperature ranges that can be used, depending on the particulate build material metal chosen or formulated for use, can be from about 800° C. to about 2,500° C., from about 1,000° C. to about 1,800° C., or from about 1,200° C. to about 1,600° C. For example, stainless steel alloys may be sinterable from about 1,100° C. to about 1,500° C., whereas copper alloys may be sinterable at a considerable lower temperature, e.g., from about 750° C. to about 1,000° C.

The particles can have a D50 particle size from about 2 μm to about 150 μm. Metal particles can have a D50 particle size that can range from about 10 μm to about 100 μm, from about 5 μm to about 125 μm, from about 20 μm to about 80 μm, from about 30 μm to about 50 μm, from about 25 μm to about 75 μm, from about 40 μm to about 80 μm, from about 50 μm to about 75 μm, from about 5 μm to about 60 μm, from about 60 μm to about 90 μm, or from about 15 μm to about 85 μm, for example. As used herein, particle size can refer to a value of the diameter of spherical particles or in particles that are not spherical can refer to the equivalent spherical diameter of that particle. The particle size can be presented as a Gaussian distribution or a Gaussian—like distribution (or normal or normal-like distribution). Gaussian-like distributions are distribution curves that can appear Gaussian in distribution curve shape, but which can be slightly skewed in one direction or the other (toward the smaller end or toward the larger end of the particle size distribution range). That being stated, an example Gaussian-like distribution of the particles can be characterized generally using “D10,” “D50,” and “D90” particle size distribution values, where D10 refers to the particle size at the 10th percentile, D50 refers to the particle size at the 50th percentile, and D90 refers to the particle size at the 90th percentile. For example, a D50 value of about 25 pm means that about 50% of the particles (by number) have a particle size greater than about 25 μm and about 50% of the particles have a particle size less than about 25 μm. Particle size distribution values are not necessarily related to Gaussian distribution curves. In practice, true Gaussian distributions are not typically present, as some skewing can be present, but still, the Gaussian-like distribution can be considered to be “Gaussian” as used in practice. Particle size distribution can be expressed in terms of D50 particle size, which can approximate average particle size, but may not be the same. In examples herein, the particle size ranges can be modified to “average particle size,” providing sometimes slightly different size distribution ranges.

A shape of the particles can be spherical, irregular spherical, rounded, semi-rounded, discoidal, angular, subangular, cubic, cylindrical, or any combination thereof. In one example, the particles can include spherical particles, irregular spherical particles, or rounded particles. In some examples, the shape of the particles can be uniform or substantially uniform, which can allow for relatively uniform melting or sintering of the particles.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “kit” can be synonymous with and understood to include a plurality of compositions including multiple components where the different compositions can be separately contained in the same or multiple containers prior to and during use, e.g., building a 3D object, but these components can be combined together during a build process. The containers can be any type of a vessel, box, or receptacle made of any material.

As used herein, “green” describes any of a number of intermediate structures prior to any particle to particle material fusing, e.g., green part, green body, green body object, green body layer, etc. As a “green” structure, the particulate build material can be (weakly) bound together by a binder. Typically, a mechanical strength of the green body is such that the green body can be handled or extracted from a particulate build material on build platform to place in an oven, for example. It is to be understood that any particulate build material that is not patterned with the binding agent is not considered to be part of the “green” structure, even if the particulate build material is adjacent to or surrounds the green body object or layer thereof. For example, unprinted particulate build material can act to support the green body while contained therein, but the particulate build material is not part of the green structure unless the particulate build material is printed with a binding agent to generate a solidified part prior to fusing, e.g., sintering, annealing, melting, etc.

The term “fuse,” “fusing,” “fusion,” “heat-fused” or the like refers to the joining of the material of adjacent particles of a particulate build material, such as by sintering, annealing, melting, or the like, and can include a complete fusing of adjacent particles into a common structure, e.g., melting together, or can include surface fusing where particles are not fully melted to a point of liquefaction, but which allow for individual particles of the particulate build material to become bound to one another, e.g., forming material bridges between particles at or near a point of contact.

As used herein, the terms three-dimensional (or 3D) “part,” “object,” “article,” or the like, refer to the target object that is being built, typically in two phases, e.g., formation of a green body object followed by heat fusion of the green body object to form a heat-fused article. The 3D object after heating to a sintering or anneal temperature sufficient for metal and/or ceramic inter-particle fusion can be referred to as a “heat-fused” article, indicating that the object has been fused together into a sturdy and rigid part, such as by sintering, annealing, melting, etc. On the other hand, the term “green body” or “green” when referring to the object, part, or article indicates that the 3D object has been solidified, but not yet heat-fused.

As used herein, “applying” when referring to a binding agent or other fluid agents that may be used, for example, refers to any technology that can be used to put or place the fluid agent, e.g., binding agent, on the particulate build material or into a layer of particulate build material for forming a 3D green body object. For example, “applying” may refer to “jetting,” “ejecting,” “dropping,” “spraying,” or the like.

As used herein, “jetting” or “ejecting” refers to fluid agents or other compositions that are expelled from ejection or jetting architecture, such as ink-jet architecture. Ink-jet architecture can include thermal or piezoelectric architecture. Additionally, such architecture can be configured to print varying drop sizes such as from about 3 picoliters to less than about 10 picoliters, or to less than about 20 picoliters, or to less than about 30 picoliters, or to less than about 50 picoliters, etc.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. Numerous modifications and alternative three-dimensional printing kits, compositions, methods, systems, etc., may be devised without departing from the spirit and scope of the present disclosure. The appended claims are intended to cover such modifications and arrangements.

### Example 1—Binding Agent Formulation

A binding agent was prepared by admixing the components indicated in Table 1 below.

TABLE 1
Binding Agent Formulation

| | | Amount |
|---|---|---|
| Component | Component Type | (wt %) |
| 1,2-Butanediol | Organic Co-solvent | 26 |
| 2-Pyrrolidone | Organic Co-solvent | — |
| 1-Methyl-2,3-Propanediol | Organic Co-solvent | — |
| TERGITOL ® 15-S-7 | Surfactant | 0.9 |
| TERGITOL ® TMN-6 | Surfactant | 0.9 |
| Latex Particles | Polymer Binder | 12 |
| Dye | Colorant | 0.4 |
| Water | Solvent | Balance |

TERGITOL ® surfactants are commercially available from Dow (USA).

### Example 2—Wetting Agent Formulations and Effect on Penetration of Binding Agent

Wetting agents were formulated by admixing the components in Tables 2A and 2B below.

TABLE 2A
Wetting Agent Formulations

| | | Wett- | Wett- | Wett- | Wett- |
|---|---|---|---|---|---|
| | | ing | ing | ing | ing |
| | | Agent | Agent | Agent | Agent |
| | Component | A | B | C | D |
| Component | Type | (wt %) | (wt %) | (wt %) | (wt %) |
| 1,2- | Organic | 10 | 20 | 10 | 20 |
| butanediol | Co-solvent | wt % | wt % | wt % | |
| Dynol ™ | Non-ionic | 1.8 | 1.8 | — | — |
| 360 | Surfactant | wt % | wt % | | |
| Capstone | Non-ionic | — | — | 1.8 | 1.8 |
| FS-35 | Surfactant | | | wt % | wt % |
| Water | Solvent | Balance | Balance | Balance | Balance |

DYNOL ™ 360 is commercially available non-ionic surfactant from Evonik Industries AG (Germany).
CAPSTONE ™ FS-35 is commercially available from The Chemours Company (USA).

TABLE 2B
Wetting Agent Formulations

| | | Wetting | Wetting | Wetting |
|---|---|---|---|---|
| | | Agent E | Agent F | Agent G |
| | Component | | | |
| Component | Type | (wt %) | (wt %) | (wt %) |
| 1,2-butanediol | Organic Co- | 10 | 20 | 20 |
| | solvent | | | |
| TERGITOL ® | Non-ionic | 0.9 | 0.9 | — |
| 15-S-7* | Surfactant | | | |
| TERGITOL ® | Non-ionic | 0.9 | 0.9 | — |
| TMN-6* | Surfactant | | | |
| Sodium Dodecyl | Anionic | — | — | 1.8 |
| Sulfate | Surfactant | | | |
| Water | Solvent | Balance | Balance | Balance |

TERGITOL ® 15-S-7 and TMN6, are commercially available from Dow, USA.

The wetting agents from Tables 2A and 2B were dispensed as 20 μL droplets onto a build material layer of 316 stainless steel particles having a D50 particle size at a value within the range of about 2 μm to about 150 μm. The build material layer thickness was about 700 μm per layer. The temperature of the powder bed material at the time of application of the agents was brought to both 45° C. and 65° C. to emulate various printing conditions. After application of the wetting agent (except for in the Control where no wetting agent was applied), the binding agent of Table 1 was subsequently dispensed as a 20 μL droplet on a build material layer. Penetration time was measured by visual observation. Time was recorded at the initial time of the drop contacting the powder and recorded again when the drop was absorbed by the powder. A penetration rate for the binding agent into the build material layer was recorded as shown in Table 3.

TABLE 3
Penetration Times

| | 45° C. Build | 65° C. Build |
|---|---|---|
| Applied Agents | Material Layer | Material Layer |
| | Penetration Time (s) | Penetration Time (s) |
| Binding Agent | 29 | 26 |
| Wetting Agent A | 6 | 9.3 |
| Binding Agent | | |
| Wetting Agent B | 10.7 | 13.3 |
| Binding Agent | | |
| Wetting Agent C | 13 | 14.3 |
| Binding Agent | | |
| Wetting Agent D | 10.7 | 8 |
| Binding Agent | | |
| Wetting Agent E | 6 | 8.7 |
| Binding Agent | | |
| Wetting Agent F | 10 | 7.3 |
| Binding Agent | | |
| Wetting Agent G | 20 | 40 |
| Binding Agent | | |

As can be seen in Table 3, a penetration rate for the binding agent into the build material layer was reduced upon application of the various wetting agents at 45° C., with Wetting Agent G providing some improvement at this temperature. The penetration rate also improved for the binding agent into the build material layer for the wetting agents, other than wetting agent G at 65° C. Notably, the Wetting Agent G included an anionic surfactant rather than a nonionic surfactant. The other wetting agents were non-ionic surfactants. Incorporating an appropriate non-ionic surfactant in the wetting agent can thus accelerate the penetration rate of the binding agents into a build material layer at both. In addition, the build material layer was visually inspected for disturbances in surface topography. Application of the wetting agent reduced disturbances related to application of the binding agent to the build material layer.

For further comparison purposes, it was found when the binding agent was deposited onto the powder bed at 65° C., for example, though there was slower penetration into the powder bed as outlined in Table 3, that penetration was accompanied by a significant disturbance in the build material layer surface, e.g., the binding agent as dispensed without wetting agent applied first generated a significant surface topography disturbance or disruption. When applying the wetting agents, on the other hand, the surface topography was not disturbed as significantly.

What is claimed is:

1. A three-dimensional printing kit comprising:
a wetting agent including:
water,
from about 5 wt % to about 60 wt % organic co-solvent, and
from about 0.1 wt % to about 10 wt % surfactant;
a binding agent including from about 2 wt % to about 25 wt % polymer binder and a liquid vehicle; and
a particulate build material including from about 80 wt % to 100 wt % metal particles having a D50 particle size ranging from about 2 μm to about 150 μm.

2. The three-dimensional printing kit of claim 1, wherein the surfactant is a nonionic surfactant.

3. The three-dimensional printing kit of claim 1, wherein the surfactant is an ethyoxylated nonionic surfactant and the organic co-solvent includes a C3 to C8 diol.

4. The three-dimensional printing kit of claim 1, wherein the organic co-solvent includes ethanol, methanol, acetone, tetrahydrofuran, hexane, 1-butanol, 2-butanol, tert-butanol, 1-propanol, isopropanol, methyl ethyl ketone, dimethylformamide, 1,4-dioxone, acetonitrile, 1,2-butanediol, 1-methyl-2,3-propanediol, 2-pyrrolidone, or a combination thereof.

5. The three-dimensional printing kit of claim 1, wherein the polymer binder includes latex polymer particles having a D50 particle size from about 50 nm to about 1 μm.

6. The three-dimensional printing kit of claim 1, wherein the metal particles include aluminum, titanium, copper, cobalt, chromium, nickel, vanadium, tungsten, tungsten carbide, tantalum, molybdenum, magnesium, gold, silver, stainless steel, tool steel, steel, an alloy thereof, or an admixture thereof.

7. A method of three-dimensional printing comprising:
iteratively applying individual build material layers of a particulate build material onto a powder bed, wherein the particulate build material includes from about 80 wt % to 100 wt % metal particles having a D50 particle size ranging from about 2 μm to about 150 μm;
based on a 3D object model, iteratively applying a wetting agent to individual build material layers, wherein the wetting agent includes water, from about 5 wt % to about 60 wt % organic co-solvent, and from about 0.1 wt % to about 10 wt % surfactant; and
based on a 3D object model, iteratively and selectively applying a binding agent to individual build material layers at locations where the wetting agent has been applied to define individually patterned object layers that become adhered to one another to form a layered green body object, wherein the binding agent includes from about 2 wt% to about 25 wt % polymer binder and a liquid vehicle, wherein a weight ratio of the polymer binder to total liquid content applied from both the wetting agent and the binding agent to individual build material layers ranges from about 1:5 to about 1:100, and wherein from about 50 wt % to about 95 wt % of total liquid content applied to individual build material layers is from the wetting agent.

8. The method of claim 7, further comprising sintering the layered green body object to form a heat-fused article.

9. The method of claim 7, wherein the fused three-dimensional object has a surface area porosity from about 0.1° A to about 10%.

10. The method of claim 7, wherein the surfactant is an ethyoxylated nonionic surfactant.

11. The method of claim 7, wherein the organic co-solvent includes ethanol, methanol, acetone, tetrahydrofuran, hexane, 1-butanol, 2-butanol, tert-butanol, 1-propanol, isopropanol, methyl ethyl ketone, dimethylformamide, 1,4-dioxone, acetonitrile, 1,2-butanediol, 1-methyl-2,3-propanediol, 2-pyrrolidone, or a combination thereof.

12. The method of claim 7, wherein the polymer binder includes latex polymer particles having a D50 particle size from about 50 nm to about 1 μm.

13. The method of claim 7, wherein the metal particles include aluminum, titanium, copper, cobalt, chromium, nickel, vanadium, tungsten, tungsten carbide, tantalum, molybdenum, magnesium, gold, silver, stainless steel, tool steel, steel, an alloy thereof, or an admixture thereof.

14. A three-dimensional printing system, comprising:
a first fluid ejector fluidly coupled to or fluidly coupleable to a wetting agent, wherein the wetting agent includes water, from about 5 wt % to about 60 wt % organic co-solvent, and from about 0.1 wt % to about 10 wt % surfactant;
a second fluid ejector fluidly coupled to or fluidly coupleable to a binding agent including from about 2 wt % to about 25 wt % polymer binder and a liquid vehicle; and
a hardware controller to generate a command to initially eject the wetting agent prior to initially ejecting the binding agent toward an individual layer of a particulate build material so that a weight ratio of the polymer binder to total liquid content from both the wetting agent and the binding agent that ejected into the individual layer is from about 1:5 to about 1:100 with from about 50 wt % to about 95 wt % of the total liquid content ejected into the individual layer is provide by the wetting agent.

15. The system of claim 14, wherein the system further comprises the particulate build material, and the particulate build material includes from about 80 wt % to 100 wt % metal particles having a D50 particle size ranging from about 2 μm to about 150 μm.
